(19) United States
(12) Patent Application Publication
(10) Pub. No.: US 2025/0119737 A1
(43) Pub. Date: Apr. 10, 2025

(54) PREVENTION OF MALICIOUS SERVICE ACCESS OVER LONG-LIVED CONNECTIONS

(71) Applicant: Oracle International Corporation, Redwood City, CA (US)

(72) Inventors: Virendra Singh, Bengaluru (IN); Jay Rajput, Bengaluru (IN); Abhilash Valappil Kunnummal, Apex, NC (US)

(21) Appl. No.: 18/482,461

(22) Filed: Oct. 6, 2023

(51) Int. Cl. H04W 12/069; H04L 9/40; H04W 12/0431

(52) U.S. Cl. CPC H04W 12/069; H04L 63/166; H04W 12/0431

(57) ABSTRACT

Various embodiments of the present technology generally relate to systems and methods for preventing malicious service access over long-lived connections. In certain embodiments, a network traffic analysis system may comprise one or more processors, and a memory having stored thereon instructions. The instructions, upon execution, may cause the one or more processors to receive, from a first network function (NF) on a 5G network, a copy of a message sent over a long-lived connection between the first NF and a second NF on the 5G network, the copy of the message including details for a transport layer security (TLS) certificate involved in the long-lived connection. The network traffic analysis system may compare the details against a list of revoked certificates to determine whether the TLS certificate has been revoked, and when the TLS certificate has been revoked, send a notification directing the first NF to close the long-lived connection.

### TECHNICAL FIELD

Various embodiments of the present technology generally relate to security within communications networks. More specifically, embodiments of the present technology relate to systems and methods for the prevention of malicious service access over long-lived network connections using a revoked security certificate.

### BACKGROUND

Malicious access by unauthorized parties (e.g., “hackers”) to communication networks is a concern for network operators. For example, a hacker may gain access to a 5GC (5G core) network system by impersonating an NF (network function), which may be a module or component of the 5GC that performs defined operations within the 5G network. By impersonating an NF, the hacker may access 5G NF topology data, discover 5G NFs, request OAuth (Open Authentication) 2.0 access tokens, or access producer NF data. 3GPP (third generation partnership project) specification TS (technical specification) 33.501 specifies the 5G SBI (service-based interface) security procedures and requirements for 5GC NFs. TS33.501 section 13.3.1.3 specifies authentication between 5GC NFs is recommended by having mutual TLS (transport layer security), which can be achieved by using TLS certificates issued by a certificate authority (CA) as per customer network deployment. If a TLS certificate is revoked for having been compromised, the certificate should not be usable to create a new secure connection between NFs.

The current certificate revocation check mechanisms, comprising CRL (certificate revocation list) or OCSP (online certificate status protocol), may be used during TLS handshake procedures between NFs, but are not used during communications over a long-lived connection (e.g., a long-lived HTTP/2 connection) that was already established before the TLS certificate was revoked. These long-lived connections may have passed initial TLS certificate verification as part of a TLS handshake, after which point the TSL certificate may not be checked again. 5G SBI service API (application programming interface) access, such as request and response communications, may continue to happen on these long-lived connections even when a certificate is marked as revoked, as the revocation check may happen only during a TLS handshake. It is possible that a hacker may have access to a legitimate NF (e.g., providing the hacker with 5G SBI services) via these long-lived connections long after the certificate is revoked. Accordingly, there exists a need for improved security on long-lived connections.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing configuration data management. In an embodiment, a network traffic analysis system may comprise one or more processors, and a memory having stored thereon instructions. The instructions, upon execution, may cause the one or more processors to receive, from a first network function (NF) on a 5G network, a copy of a message sent over a long-lived connection between the first NF and a second NF on the 5G network, the copy of the message including details for a transport layer security (TLS) certificate involved in the long-lived connection. The network traffic analysis system may compare the details against a list of revoked certificates to determine whether the TLS certificate has been revoked, and when the TLS certificate has been revoked, send a notification directing the first NF to close the long-lived connection.

In some embodiments, the long-lived connection comprises a connection that remains open after an initial TLS handshake between the first NF and the second NF used to verify the TLS certificate, without a subsequent check of the TLS certificate. The long-lived connection may comprise an HTTP/2 connection. According to some embodiments, the network traffic analysis system may access a public key infrastructure (PKI) system to obtain the list of revoked certificates. In some examples, the list of revoked certificates comprises a certificate revocation list (CRL), while in other embodiments the list of revoked certificates comprises an online certificate status protocol (OCSP). In some embodiments, the network traffic analysis system may, when the TLS certificate has not been revoked, send a notification to the first NF indicating that the TLS certificate is valid. In some examples, the message includes a service-based interface (SBI) communication. According to some embodiments, the network traffic analysis system, the first NF, and the second NF are components of a 5GC (5G core) network. The network traffic analysis system may, when the TLS certificate has been revoked, send a message to multiple NFs in the 5GC network indicating the TLS certificate has been revoked.

In an alternative embodiment, a method may comprise operating a network traffic analysis system of a 5G network, including receiving, from a first network function (NF) on the 5G network, a copy of a message sent over a long-lived connection between the first NF and a second NF on the 5G network, the copy of the message including details for a transport layer security (TLS) certificate involved in the long-lived connection. The method may further include comparing the details against a list of revoked certificates to determine whether the TLS certificate has been revoked, and sending a notification directing the first NF to close the long-lived connection when the TLS certificate has been revoked.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement prevention of malicious service access over long-lived connections, in accordance with certain embodiments of the present disclosure;

FIG. 2 depicts a flow diagram of an example method for prevention of malicious service access over long-lived connections, in accordance with certain embodiments of the present disclosure;

FIG. 3 depicts a flow diagram of an example method for prevention of malicious service access over long-lived connections, in accordance with certain embodiments of the present disclosure;

FIG. 4 depicts a flowchart of an example method for prevention of malicious service access over long-lived connections, in accordance with certain embodiments of the present disclosure;

FIG. 5 depicts a flowchart of an example method for prevention of malicious service access over long-lived connections, in accordance with certain embodiments of the present disclosure; and

FIG. 6 is a diagram of a system configured to implement prevention of malicious service access over long-lived connections, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

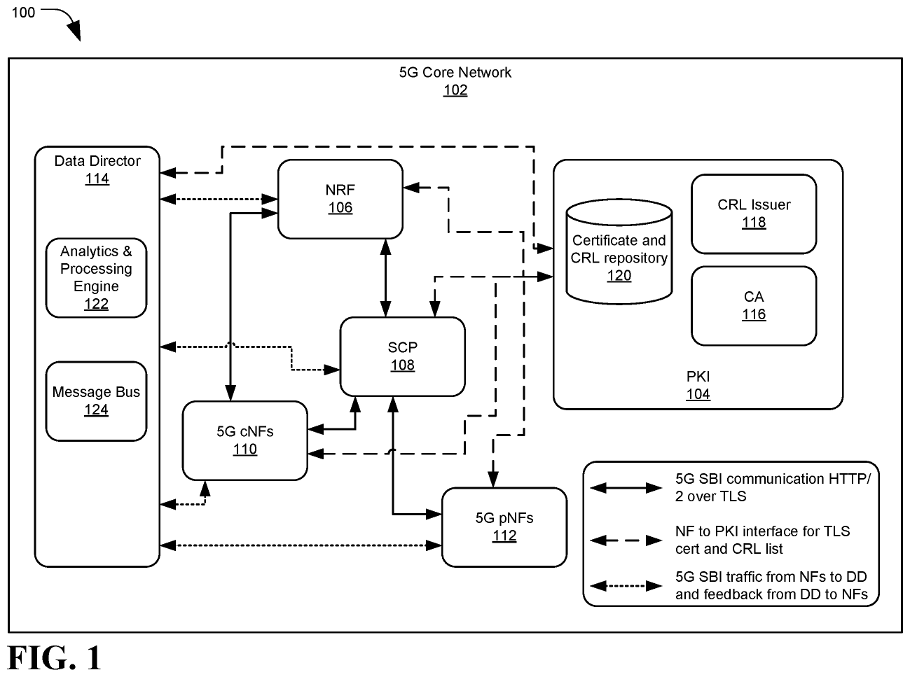

FIG. 1 is a diagram of a system 100 configured to implement prevention of malicious service access over long-lived connections, in accordance with certain embodiments of the present disclosure. The example system 100 may include a mobile network comprising a 5G core (5GC) network 102 implementing 3GPP (3rd Generation Partnership Project) communication standards, although the present disclosure may apply to other communication networks. The 5GC network 102 may include a public key infrastructure (PKI) system 104, a network repository function (NRF) 106, a service controller proxy or service communications proxy (SCP) 108, a 5G consumer network function (cNF) 110, a 5G producer network function (pNF) 112, and a data director 114.

Each or any of 5GC 102, its components, and their sub-components may be implemented via computers, servers, hardware and software modules, or other system components. The components of 5GC network 102 and its subcomponents, or the physical devices implementing them, may be co-located, remotely distributed, or any combination thereof. The elements of system 100 may include components hosted or situated in the cloud, and implemented as software modules potentially distributed across one or more server devices or other physical components.

PKI 104 may comprise a set of systems that governs the issuance of digital certificates to protect sensitive data, provide unique digital identities for users, devices, and applications, and secure end-to-end communications. PKI 104 may manage usage of keys involved in public key encryption, which may rely on public keys that are available to all, and corresponding private keys or secret keys, which may only be available to a single entity, and can decrypt messages encrypted with the public key. PKI 104 may issue and manage digital certificates that verify the owner of a private key, and thereby validate the authenticity of the identity of the private key holder. PKI 104 and its components may be part of the 5GC network 102, or external to it.

PKI 104 may include a certificate authority (CA) 116, a certificate revocation list (CRL) issuer 118, and a certificate and CRL repository 120. The CA 116 may be a trusted source of PKI certificates, so that certificates that are digitally signed by the CA 116 are trusted as authentic by entities of a network. CAs 116 may be responsible for indicating the revocation status of the certificates that they issue. When a CA 116 becomes aware that a key and certificate issued to an entity has been compromised (e.g., a hacker or unauthorized party has gotten access to them), the CA may set a status for the certificate as “revoked” and no longer valid. Revocation status information may be provided using the Online Certificate Status Protocol (OCSP), certificate revocation lists (CRLs), or some other mechanism.

The CRL issuer 118 may be a system that generates and signs CRLs identifying revoked certificates. In general, when revocation status information is provided using CRLs, the CA 116 may also be the CRL issuer 118. However, a CA 116 may delegate the responsibility for issuing CRLs to a different entity.

The certificate and CRL repository 120 may include a system or collection of distributed systems that stores certificates and CRLs and serves as a means of distributing these certificates and CRLs to end entities. When performing a TLS handshake to verify the authenticity of another entity, a system on the network may access the certificate and CRL repository 120 to compare a certificate received in the handshake against the certificates in the repository 120. If the certificate is identified as valid, the TLS handshake may be completed, and the entity authenticated. If the received certificate is on the CRL list, however, the TLS handshake may fail, and the connection rejected. In some embodiments, network entities may obtain or download a current or updated list of certificates and CRLs periodically, rather than accessing the certificate and CRL repository 120 for every handshake or new connection. The certificate and CRL repository 120 may be maintained and updated by the CA 116, the CRL issuer 118, some other entity of the PKI system 104, or a combination thereof.

A network repository function or NF repository function (NRF) 106 may be a monitoring element which includes and maintains a repository of the NF elements of the 5GC network 102, including what services or resources each provides. The NRF 102 may perform both discovery operations to add NFs to the NRF, as well as operations to keep the NRF updated. For example, NFs may register with the NRF to provide registration information for the NF to the NRF for storing in the repository. Once an NF is registered with the NRF, the NRF may provide information for the NF in response to discovery requests. An NF and the NRF 106 may perform a TLS handshake operation to authenticate the NF to the NRF 106 for registration.

A service controller or communications proxy (SCP) 108 may subscribe with the NRF 106 and obtain reachability and service profile information regarding producer NF service instances (e.g., 5G pNFs 112). Consumer NFs (e.g., 5G cNFs 110) may connect to the SCP 108, and the SCP may load balance traffic among producer NF service instances 112 that provide the required service, or directly routes the traffic to the destined producer NF 112.

A network node that provides service may be referred to as a 5G producer NF (5G pNF) 112, while a network node that consumes services may be referred to as a 5G consumer NF (5G cNF 110). A network function can be both a producer NF and a consumer NF depending on whether it is consuming or providing service.

The NFs of the 5GC network 102, including NRF 106, SCP 108, 5G cNFs 110, and 5G pNFs 112, may exchange 5G SBI communications with each other, as denoted by the solid arrow communication lines in FIG. 1. These communications may be implemented over long-lived connections over TLS, such as HTTP/2 long-lived connections, where an initial TLS handshake is performed to open the communication channel, and then the channel remains open for a potentially extended duration without further security checks. The NFs 106-112 may communicate with the PKI 104, as denoted by the dashed arrow communication lines, to obtain TLS certificate and CRL list information, such as from the certificate and CRL repository 120. The NFs may use the certificate and CRL information during TLS handshake operations to verify other 5GC NFs and establish long-lived connections. NFs may establish a connection on a socket or port, and once established it can continue to be used.

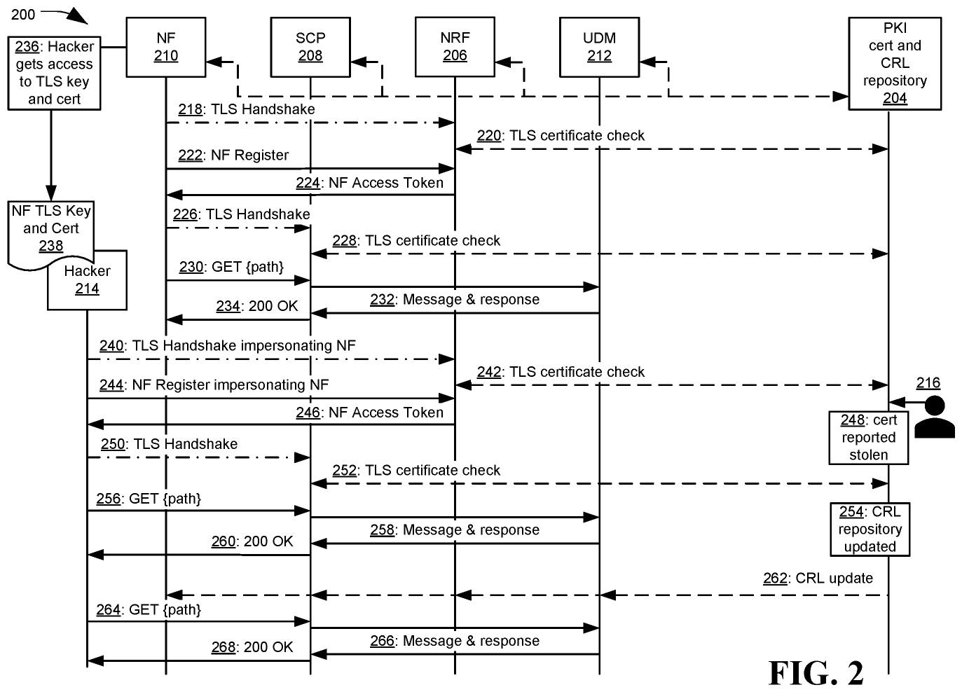

Security issues may arise with long-lived connections, wherein a stolen certificate is used by a malicious party to access or impersonate an NF in the 5GC network 102. Even if the stolen certificate is discovered and added to the CRL list, any long-lived connections established prior to the certificate being added to the CRL list may continue to be used by the malicious party. This process is discussed in regard to FIG. 2.

FIG. 2 depicts a flow diagram 200 of an example method for prevention of malicious service access over long-lived connections, in accordance with certain embodiments of the present disclosure. In particular, diagram 200 depicts a communication flow between NFs and a PKI system in a 5GC network, in which a hacker 214 gains access to the 5GC network using long-lived connections, and can maintain those connections even after the compromised certificate is discovered and added to a CRL list. The entities involved in the process flow may include an NF 210 (which may correspond to a consumer NF), an SCP 208, an NRF 206, a unified data management (UDM) NF 212 (which may correspond to a producer NF), a PKI certificate and CRL repository 204, the hacker 214, and a network operator 216. The components in diagram 200 may correspond to elements described in regard to FIG. 1.

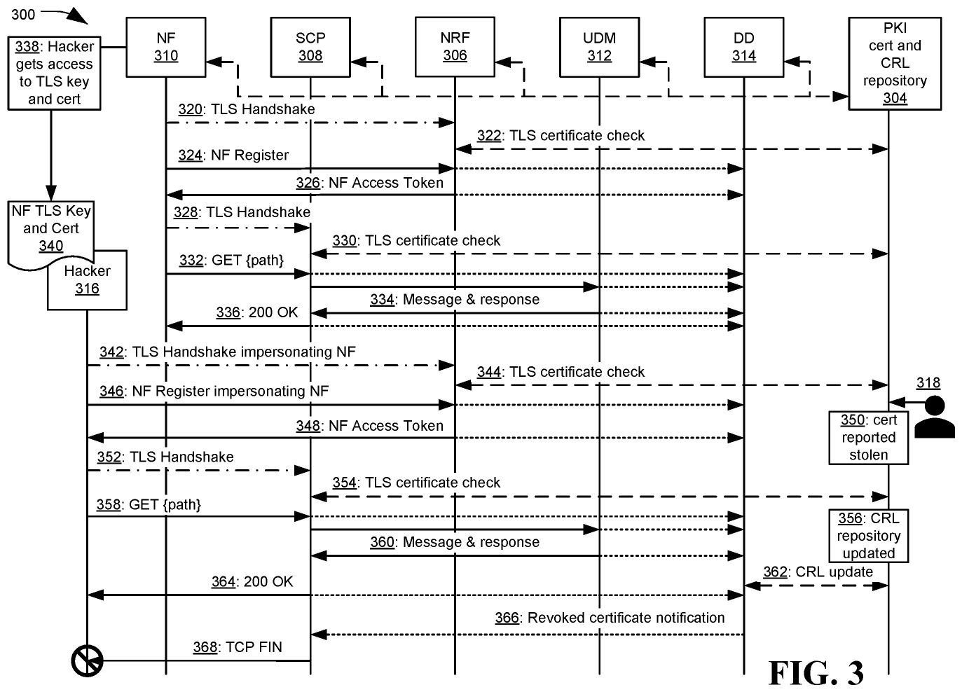

At 218, NF 210 may initiate a TLS handshake with NRF 206. TLS handshakes, as depicted in FIGS. 2 and 3, may be represented by dot-dash lines, while communications to PKI 204 may be represented by dashed lines, and SBI communications between NFs may be represented by solid lines. The handshake operation may include the NF 210 providing a copy of its TLS certificate, or certificate details (e.g., the issuer name and serial number that together identify a unique certificate), to NRF 206. At 220, the NRF 206 may use the certificate details to perform a TLS certificate check or verification with PKI certificate and CRL repository 204, and receive a response indicating the certificate is valid. The PKI certificate and CRL repository 204 may be local to the 5G network system, or may be remote.

Once the certificate has been authenticated, the TLS handshake may be completed, and a long-lived connection may be established between NF 210 and NRF 206. At 222, the NF 210 may register with the NRF 206 to be added to the NRF's list of valid NFs in the 5GC network. At 224, the NRF 206 may provide the NF 210 with an NF access token. The NF access token may be used in requests to an NF resource by placing it in an Authorization header.

At 226, NF 210 may initiate a TLS handshake with SCP 208, following the same TLS handshake protocol as used with NRF 206 at 218. The SCP 208 may perform a TLS certificate check with PKI certificate and CRL repository at 228, and receive a verification for NF's 210 certificate. Once authenticated, a long-lived connection may be established between NF 210 and SCP 208.

At 230, NF 210 may issue an SBI service request to SCP 208 using the long-lived connection, such as a ‘GET {path}’ communication. Based on the request, at 232 the SCP 208 may identify an appropriate producer NF in UDM 212, and send a message and receive a response. At 234, the SCP 208 may provide a reply to NF 210, such as a ‘200 OK’ message indicating successful completion of the operation with UDM 212.

At 236, hacker 214 may get access to the TLS private key and certificate 238 belonging to NF 210. Based on the stolen key and certificate 238, the hacker 214 may initiate a TLS handshake operation with NRF 206 at 240, impersonating NF 210. As the functionality of NF 210 may be spread over one or more physical or virtual systems, it may not be unusual for the same certificate to be used to register multiple systems with the NRF 206. Accordingly, at 242, NRF 206 may perform a TLS certificate check with PKI certificate and CRL repository 204, and receive a response authenticating the stolen certificate. By completing the TLS handshake with NRF 206, the hacker 214 has established a long-lived connection with the NRF 206. At 244, the hacker 214 may then register with the NRF 206 by impersonating NF 210 with the stolen certificate, and may receive an NF access token at 246.

At 248, network operator 216 may suspect or become aware that the NF TLS key and certificate 238 for NF 210 has become compromised, and may notify the PKI certificate and CRL repository 204. In some embodiments, updates to the CRL repository may be performed at intervals, and therefore the CRL repository 204 may not be updated immediately.

At 250, the hacker 214, using the NF access token received at 246 and the stolen TLS key and certificate 238, may perform a TLS handshake operation with SCP 208. SCP 208 may perform the TLS certificate check with PKI certificate and CRL repository 204 at 252, and may receive an indication that the stolen certificate is still valid, thereby establishing a long-lived connection between hacker 214 and SCP 208.

At 254, the CRL repository 204 may be updated, and the stolen certificate 238 may be added to the CRL list. However, since a long-lived connection has already been established between hacker 214 and SCP 208, at 256 the hacker may perform a 5G SBI service request to the SCP. At 258, the SCP 208 may issue a message and receive a response from UDM 212, and may provide a response to the hacker at 260. The hacker 214 was able to access 5G SBI services even after its stolen certificate was added to the CRL list.

At 262, the CRL update 262 may potentially be provided to NFs 206-210, or the NFs may have accessed the PKI certificate and CRL repository 204 after the CRL was updated. Nevertheless, at 264, the hacker 214 may issue another 5G SBI request to SCP 208 over the previously established long-lived connection. At 266, the SCP 208 may message and receive a response from UDM 212, and may provide a service response to the hacker at 268. At this point, the hacker 214 may be able to use any already-established long-lived connections to continue receiving SBI services, despite its certificate having been added to the CRL repository 204.

Returning to FIG. 1, a proposal to improve security for long-lived connections is shown. A data director 114, such as an Oracle® Communications Network Analytics Data Director (OCNADD), may be a network traffic analysis entity deployed in the 5GC network 102 which receives the 5G SBI traffic feed from each of the NFs (106-112) deployed in the network 102, and may analyze the traffic and provide feedback. Communications between data director 114 and NFs 106-112 may be depicted via dotted arrow communication lines. The data director 114 may include a message bus 124 to manage incoming traffic and outgoing responses or feedback, and an analytics and processing engine 122 to evaluate received traffic and messages, and to formulate feedback or notifications to provide back to NFs.

When NFs 106-112 communicate, they may send a copy the 5G SBI traffic to the data director 114. The TLS certificate details exchanged between the NFs 106-112 as part of the TLS handshake and certificate verification, may be included along with the 5G SBI messages provided to the data director 114 in the traffic feed. The certificate information may be provided for any traffic over a long-lived connection, and not only for the initial TLS handshake communications. The data director 114 may periodically obtain or be provided with a copy of the CRL list from the certificate and CRL repository 120 (e.g., via message bus 124). The data director 114 may analyze the 5G SBI traffic and certificate details based on the CRL list (e.g., via analytics and processing engine 122), and may provide feedback to the NFs 106-112 based on the analysis. The data director 114 may provide feedback to NFs if any message is being received over a long-lived TLS connection using revoked certificate, and may instruct or direct the NF to end the connection. In some examples, the data director 114 may provide feedback indicating that a certificate involved in a message is still valid.

Based on the notification or feedback from data director 114 regarding 5G SBI communication using a revoked certificate, NFs 106-112 may terminate the respective long-lived TLS connection which was established using the revoked certificate. For example, the NF may send a Transmission Control Protocol (TCP) FIN packet or flag to end the connection, or otherwise terminate the long-lived connection. Once a connection between NEs has been ended, a new TCP handshake may be required for further communications, which may fail when using a revoked certificate. In this manner, 5G SBI service access may be prevented on long-lived TLS connections that were established using a revoked TLS certificate. The security may be implemented with no or minimal changes to NEs outside of data director 114. An example of a system employing the data director 114 is discussed in regard to FIG. 3.

FIG. 3 depicts a flow diagram 300 of an example method for prevention of malicious service access over long-lived connections, in accordance with certain embodiments of the present disclosure. In particular, diagram 300 depicts a communication flow between NEs and a PKI system in a 5GC network, in which a hacker 316 gains access to the 5GC network using long-lived connections. As opposed to the flow diagram 200 of FIG. 2, however, flow diagram 300 includes a data director (DD) 314 which may be configured to notify NFs of communications over long-lived channels established using a revoked certificate, and can thereby prevent the hacker 316 from maintaining the connections after the stolen certificate is discovered and added to a CRL list. The entities involved in the process flow may include the hacker 316 and the DD 314, as well as an NF 310 (which may correspond to a consumer NF), an SCP 308, an NRF 306, a unified data management (UDM) NF 312 (which may correspond to a producer NF), a PKI certificate and CRL repository 304, and a network operator 318. The components in diagram 300 may correspond to elements described in regard to FIG. 1 and FIG. 2.

Similar to the process described in FIG. 2, at 320 NF 310 may initiate a TLS handshake operation with NRF 306. The handshake operation may include the NF 310 providing a copy of its TLS certificate, or certificate details (e.g., the issuer name and serial number that together identify a unique certificate), to NRF 306. At 322, the NRF 206 may use the certificate details from NF 310 to perform a TLS certificate check or verification with PKI certificate and CRL repository 304, and receive a response indicating the certificate is valid. The PKI certificate and CRL repository 304 may be local to the 5G network system, or may be remote. Based on the successful certificate check 322, a long-lived connection may be established between NF 310 and NRF 306.

At 324, the NF 310 may register with the NRF 306 to be added to the NRF's list of valid NFs in the 5GC network. A new aspect of flow diagram 300 as compared to flow diagram 200 is that NFs within the 5GC network may send a copy of their communications (or a subset of communications, such as SBI communications) to DD 314, as indicated by the dotted line communications in flow diagram 300. An NF may send the DD 314 a copy of communications it sends, communications it receives, or both. Accordingly, NF 310 may send a copy of the NF registration communication 324, along with TLS certificate information for one or more of the NFs involved in the communication, to the DD 314. In some examples, the NRF 306 that received the NF registration communication 324 may also send a copy of it to the DD 314. For each received message, the DD may perform analysis and processing, which may include comparing TLS certificate information from the 5G SBI traffic communications with the CRL repository information from PKI certificate and CRL repository 304. Although the traffic flow from NFs to DD 314 are generally depicted as a dotted long corresponding to a 5G SBI traffic communication, in some examples the dotted line may also represent a response or notification returned from the DD 314 to the NF that sent the traffic transmission.

At 326, the NRF 306 may provide the NF 310 with an NF access token. The NRF 306 may be sending copies of its traffic with NF 310 to the DD 314, and may be including certificate details from NF 310 for each message that is exchanged over a long-lived connection. In some embodiments. NFs may only send DD 314 copies of messages that the NF sends, while in other embodiments NFs may also send the DD 314 copies of messages it receives as well. Other embodiments are also possible, including only sending selected types of messages, or only sending traffic between selected types of NFs.

At 328, NF 310 may initiate a TLS handshake with SCP 308, following the same TLS handshake protocol as used with NRF 306 at 320. The SCP 308 may perform a TLS certificate check with PKI certificate and CRL repository 304 at 330, and receive a verification for NF's 310 certificate. Once authenticated, a long-lived connection may be established between NF 310 and SCP 308. Steps 332 to 336 depict the NF 310 requesting a 5G SBI service request from UDM 312 via SCP 308, and receiving a response, as described in steps 230-234 of FIG. 2, with the additional aspect of the 5GC NFs sending a copy of the traffic to DD 314.

At 338, hacker 316 may get access to the TLS private key and certificate 340 belonging to NF 310. Based on the stolen key and certificate 340, the hacker 314 may initiate a TLS handshake operation with NRF 306 at 342, impersonating NF 310. At 344, NRF 306 may perform a TLS certificate check with PKI certificate and CRL repository 304, and receive a response authenticating the hacker's 316 stolen certificate. By completing the TLS handshake with NRF 306, the hacker 316 can establish a long-lived connection with the NRF 306.

At 346, the hacker 316 may then register with the NRF 306 by impersonating NF 310 with the stolen certificate, and may receive an NF access token at 348. It may be noted here that hacker 316 may not be sending copies of its messages to DD 314, as it may not have access to DD. The DD 314 may be configured with other security measures or requirements, so that entities outside of the 5GC network run by operator 318, such as hacker 316, may not know of or have means to send messages to DD 314. However, the receiving NF, in this case NRF 306, may still send a copy of the received NF registration communication 346, to the DD 314.

At 350, network operator 318 may suspect or become aware that the NF TLS key and certificate 340 for NF 310 has been compromised, and may notify the PKI certificate and CRL repository 304.

At 352, the hacker 316, using the NF access token received at 348 and the stolen TLS key and certificate 340, may perform a TLS handshake operation with SCP 308. SCP 308 may perform the TLS certificate check with PKI certificate and CRL repository 304 at 354, and may receive an indication that the stolen certificate is still valid, thereby establishing a long-lived connection between hacker 316 and SCP 308.

At 356, the CRL repository 304 may be updated, and the stolen certificate 340 may be added to the CRL list, but this may not automatically result in the termination of long-lived connections using the stolen certificate that were established before the CRL list was updated.

At 358 the hacker may perform a 5G SBI service request to the SCP 308. At 360, the SCP 308 may issue a message and receive a response from UDM 312. The SCP 308 and UDM 312 may provide a copy of these communications to the DD 314, but in the depicted example the DD 314 may not have obtained a copy of the updated CRL list yet to determine that the stolen certificate 340 in play has been revoked. The DD 314 may access the PKI certificate and CRL repository 304 at 362, and may now have an updated listing that identifies certificate 340 as revoked.

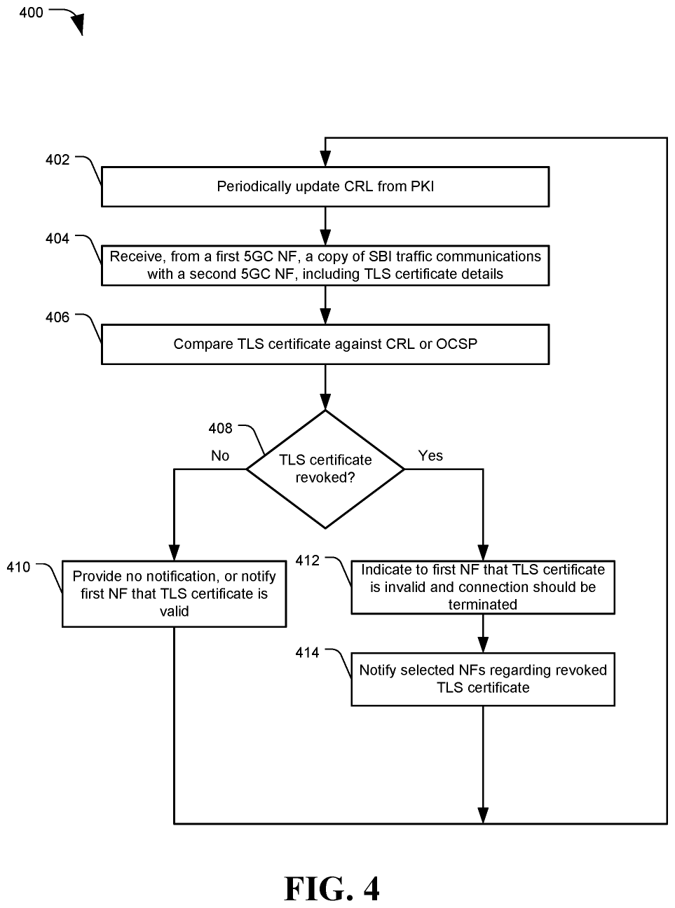

At 364, the SCP 308 may send a response to hacker 316 regarding the service request issued at 358. The SCP 308 may also send a copy of the message to DD 314. In response, DD 314 may send a revoked certificate notification to SCP 308 at 366, informing the SCP 308 that the long-lived connection with hacker 316 was established with a certificate that is now revoked, and that the connection should be terminated. Based on the notification, the SCP 308 may close the long-lived connection at 368, such as by sending a TCP FIN or GOAWAY message. Accordingly, if hacker 316 attempted to send another service request, the request would be denied, or the long-lived connection may be closed before the request could be sent. To continue to access 5G SBI services, the hacker 316 would need to initiate a new TLS handshake, which would fail due to the stolen NF TLS key and certificate 340 having been revoked. A flowchart of the process performed by DD 314 is described in regard to FIG. 4.

FIG. 4 depicts a flowchart 400 of an example method for prevention of malicious service access over long-lived connections, in accordance with certain embodiments of the present disclosure. In particular, flowchart 400 depicts an example process implemented by a data director to monitor 5G SBI traffic for long-lived connections established using a certificate on a certificate revocation list (CRL). The method of FIG. 4 may be performed by data director 114 of FIG. 1, including analytics and processing engine 122 and message bus 124.

The method may include periodically updating a local copy of the CRL from a PKI system, at 402. The updates may occur at specific selected times, at designated time intervals, at intervals based on messages sent or received, based on workload openings or lulls, or based on other factors. The updates may occur at any point of the flowchart 400.

At 404, the method may include receiving, from an NF in a 5GC network, a copy of 5G SBI traffic communications, including TLS certificate details used in the establishment of the communication channel between the communicating NFs. In one example, the traffic could include a copy of a service request received at a producer NF from a consumer NF. In another example, the traffic could include a message from a first NF that the first NF has sent or is sending to a second NF (e.g., the DD may be copied on all 5G SBI messages between 5GC NFs). The certificate details may include an issuing CA name and certificate serial number, which may be used to uniquely identify a certificate. The certificate details for one or both NFs involved in a message may be included with each transmission sent to the DD, or may only be included for messages being sent over long-lived TLS connections.

At 406, the method may include comparing the TLS certificate details against the CRL or OCSP (e.g., comparing to a local copy of revoked certificate information, or accessing the PKI system to compare against a revoked certificate repository). A determination may be made whether a TLS certificate from the 5G SBI message has been revoked, at 408. If not, the method may include providing no notification regarding the TLS certificate, or notifying the NF that sent the message that the TLS certificate is valid, at 410.

If a determination is made that a TLS certificate in the communication is revoked, the method may include providing an indication to the sending NF that the TLS certificate is invalid and any long-lived connection with the corresponding NF should be terminated, at 412. In some examples, the method may include notifying selected NFs regarding the revoked TLS certificate, in addition to the NF that sent the transmission to the DD at 404.

Regarding notifications from the DD to NFs, in some examples the DD may not provide any feedback when no problems are detected, and may only send notifications when an issue such as a revoked certificate is determined. In some examples, the method may include sending notifications to only the NF that sent the copy of the transmission to the DD, while in other examples the DD may send notifications to both or all NFs involved in a communication. In another example, the notification may only be sent to the NF that does not correspond to the revoked certificate (e.g., so as to not notify a malicious party that the revoked certificate has been detected). Regarding sending notifications to other selected NFs, at 414, in some 5GC network architectures, certain NFs may be the most likely to be accessed by a malicious entity for 5G SBI services, such as NRFs and SCPs. The method may include notifying all such high-risk NFs when a revoked certificate is detected so that they can close any existing long-lived connections involving that certificate. This may prevent a hacker from accessing any other services besides the current NF that sent the message to the DD.

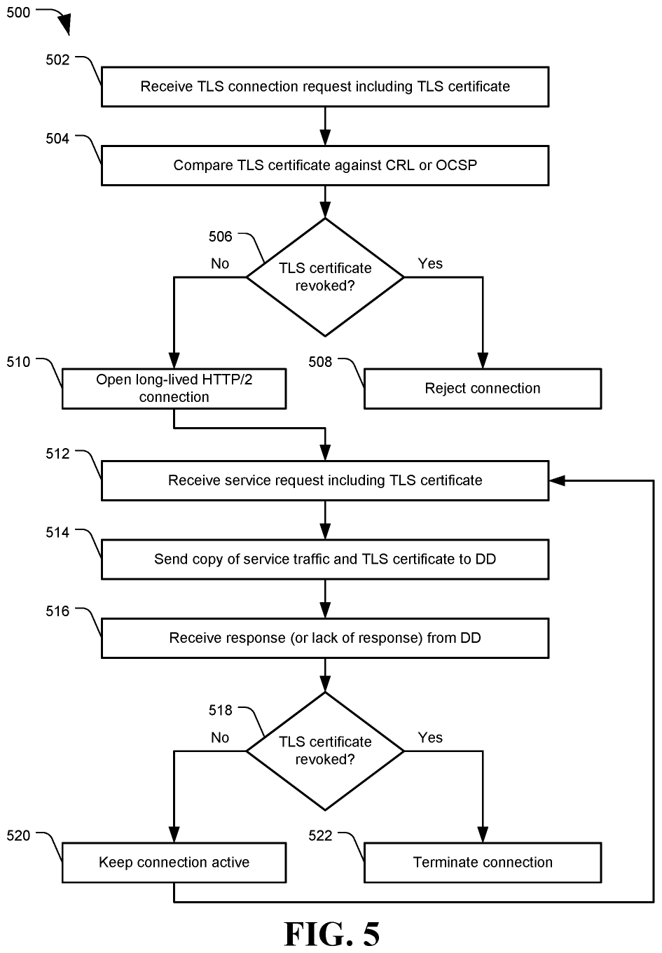

Once a message has been evaluated and a certificate determined to be valid or invalid, the method may include returning to 402 to update a CRL list, and continuing to monitor for other SBI traffic, at 404. FIG. 5 depicts an example of an NF within a 5GC network configured to send copies of SBI traffic to a data director.

FIG. 5 depicts a flowchart 500 of an example method for prevention of malicious service access over long-lived connections, in accordance with certain embodiments of the present disclosure. In particular, flowchart 500 depicts an example process implemented by a network function (NF) in a 5GC network system including a data director (DD) used to monitor 5G SBI traffic for long-lived connections established using a certificate on a certificate revocation list (CRL). The method of FIG. 5 may be performed by NRF, SCP, or other function to which a malicious entity may establish a long-lived connection to access 5G SBI services, such as NRF 106 or SCP 108 of FIG. 1.

The method may include receiving a TLS connection request including TLS certificate details, at 502. The TLS connection request may include initiating a TLS handshake operation to authenticate the requesting party and to establish a long-lived TLS connection, such as an HTTP/2 connection. The method may include comparing the TLS certificate details against a CRL or OCSP, either stored locally or by accessing a PKI service.

At 506, a determination may be made whether the TLS certificate has been revoked. If yes, the method may include rejecting the connection at 508, and the method may end. If the TLS certificate has not been revoked, the method may include opening a long-lived TLS connection, at 510.

Once a long-lived connection has been established, the method may include receiving a service request, at 512. The request may include a copy of the certificate or certificate details, or the receiving NF may store a copy of the certificate details from the TLS handshake operation for open long-lived connections. At 514, the method may include sending a copy of service traffic message(s) and the TLS certificate details to the DD. The message may be the service request received at 512, or a response message, or any combination of service traffic including the long-lived connection. At 516, the method may include receiving a response from the DD to the message from 514, which may provide an indication or feedback on the validity of the TLS certificate. The response of 516 may be received after a delay, so that the NF continues to perform other operations between sending the copy of the traffic at 514 and receiving the response at 516. In some examples, no response may be received at 516, such as in embodiments where a notification is only sent by the DD when a revoked TLS certificate is identified.

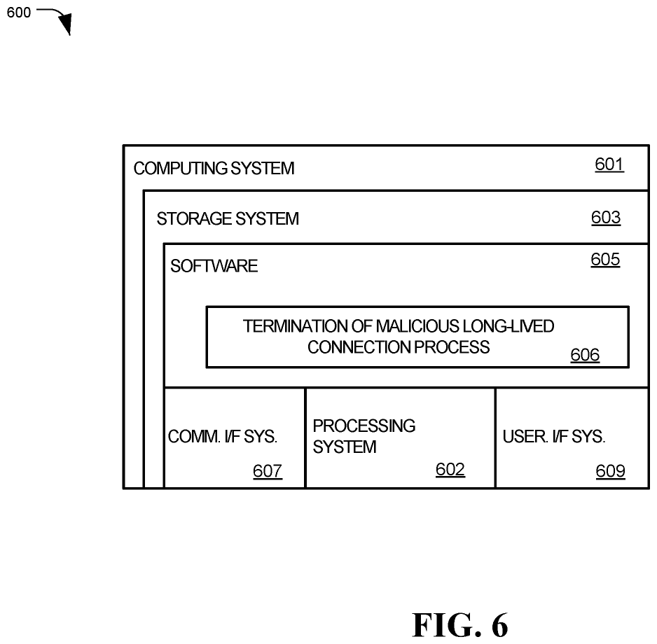

At 518, based on the response from the DD (or in some embodiments, based on a lack of response), a determination may be made whether the TLS certificate has been revoked at some point after the TLS handshake operation. If so, the method may include terminating the long-lived connection, at 522, where the method may end. However, if the TLS certificate is not revoked, the method may include keeping the long-lived connection open, and continuing to process service requests from the associated NF, at 520. The method may then include receiving a next service request over the long-lived connection, at 512. A computing system configured to perform the operations and methods described herein is provided in regard to FIG. 6.

FIG. 6 is a diagram of a system configured to implement prevention of malicious service access over long-lived connections, in accordance with certain embodiments of the present disclosure. System 600 may be an example of an apparatus including a computing system 601 that is representative of any system or collection of systems in which the various processes, systems, programs, services, and scenarios disclosed herein may be implemented. For example, computing system 601 may be an example data director 114, NRF 106, SCP 108, 5G cNFs 110, 5G pNFs 112, or any of the subcomponents depicted in system 100 of FIG. 1. Examples of computing system 601 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 601 may be implemented as a single apparatus, system, or device or may be implemented in a distributed manner as multiple apparatuses, systems, or devices. Computing system 601 may include, but is not limited to, processing system 602, storage system 603, software 605, communication interface system 607, and user interface system 609. Processing system 602 may be operatively coupled with storage system 603, communication interface system 607, and user interface system 609.

Processing system 602 may load and execute software 605 from storage system 603. Software 605 may include a termination of malicious long-lived connection process 606, which may be representative of any of the operations for monitoring SBI traffic over long-lived connections for TLS certificates that have been included on a certificate revocation list (CRL) or online certificate status protocol (OCSP) as revoked, and terminating those long-lived connections, as discussed with respect to the preceding figures. When executed by processing system 602, software 605 may direct processing system 602 to operate as described herein for at least the various processes, operational scenarios, and sequences discussed in the foregoing implementations. Computing system 601 may optionally include additional devices, features, or functionality not discussed for purposes of brevity.

In some embodiments, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 may include general purpose central processing units, graphical processing units, application specific processors, and logic devices, as well as any other type of processing device, combinations, or variations thereof.

Storage system 603 may comprise any memory device or computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including termination of malicious long-lived connection process 606 among other functions) may be implemented in program instructions that may, when executed by processing system 602, direct processing system 602 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system as described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems. not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A network traffic analysis system, comprising:
one or more processors; and
a memory having stored thereon instructions that, upon execution by the one or more processors, cause the one or more processors to:
receive, from a first network function (NF) on a 5G network, a copy of a message sent over a long-lived connection between the first NF and a second NF on the 5G network, the copy of the message including details for a transport layer security (TLS) certificate involved in the long-lived connection;
compare the details against a list of revoked certificates to determine whether the TLS certificate has been revoked; and
when the TLS certificate has been revoked, send a notification directing the first NF to close the long-lived connection.

2. The network traffic analysis system of claim 1, wherein the long-lived connection comprises a connection that remains open after an initial TLS handshake between the first NF and the second NF used to verify the TLS certificate, without a subsequent check of the TLS certificate.

3. The network traffic analysis system of claim 2, wherein the long-lived connection comprises an HTTP/2 connection.

4. The network traffic analysis system of claim 2, wherein the instructions comprise further instructions that, upon execution by the one or more processors, cause the one or more processors to:
access a public key infrastructure (PKI) system to obtain the list of revoked certificates.

5. The network traffic analysis system of claim 4, wherein the list of revoked certificates comprises a certificate revocation list (CRL).

6. The network traffic analysis system of claim 4, wherein the list of revoked certificates comprises an online certificate status protocol (OCSP).

7. The network traffic analysis system of claim 4, wherein the instructions comprise further instructions that, upon execution by the one or more processors, cause the one or more processors to:
when the TLS certificate has not been revoked, send a notification to the first NF indicating that the TLS certificate is valid.

8. The network traffic analysis system of claim 4, wherein the message includes a service-based interface (SBI) communication.

9. The network traffic analysis system of claim 4, wherein the network traffic analysis system, the first NF, and the second NF are components of a 5GC (5G core) network.

10. The network traffic analysis system of claim 9, wherein the instructions comprise further instructions that, upon execution by the one or more processors, cause the one or more processors to:
when the TLS certificate has been revoked, send a message to multiple NFs in the 5GC network indicating the TLS certificate has been revoked.

11. A method comprising:
operating a network traffic analysis system of a 5G network, including:
receiving, from a first network function (NF) on the 5G network, a copy of a message sent over a long-lived connection between the first NF and a second NF on the 5G network, the copy of the message including details for a transport layer security (TLS) certificate involved in the long-lived connection;
comparing the details against a list of revoked certificates to determine whether the TLS certificate has been revoked; and
sending a notification directing the first NF to close the long-lived connection when the TLS certificate has been revoked.

12. The method of claim 11, wherein the long-lived connection comprises a connection that remains open after an initial TLS handshake between the first NF and the second NF used to verify the TLS certificate, without a subsequent check of the TLS certificate.

13. The method of claim 11, wherein the long-lived connection comprises an HTTP/2 connection.

14. The method of claim 11 further comprising:
accessing a public key infrastructure (PKI) system to obtain the list of revoked certificates.

15. The method of claim 14, wherein the list of revoked certificates comprises a certificate revocation list (CRL).

16. The method of claim 14, wherein the list of revoked certificates comprises an online certificate status protocol (OCSP).

17. The method of claim 11 further comprising:
sending a notification to the first NF indicating that the TLS certificate is valid when the TLS certificate has not been revoked.

18. The method of claim 11, wherein the message includes a service-based interface (SBI) communication.

19. The method of claim 11, wherein the network traffic analysis system, the first NF, and the second NF are components of a 5GC (5G core) network.

20. The method of claim 19 further comprising:
sending a message to multiple NFs in the 5GC network indicating the TLS certificate has been revoked based on the list of revoked certificates indicating TLS certificate has been revoked.
